(19) United States
(12) Patent Application Publication
(10) Pub. No.: US 2012/0216387 A1
(43) Pub. Date: Aug. 30, 2012

(54) Apparatus Facilitating Application of Customized Portable Spa Surrounds By End Users

(76) Inventors: Jake Dragovich, Vista, CA (US); Steven M. Hammock, Encinitas, CA (US)

(21) Appl. No.: 13/457,270

(22) Filed: Apr. 26, 2012

Related U.S. Application Data
(62) Division of application No. 12/185,742, filed on Aug. 4, 2008.

(51) Int. Cl. B23P 17/04

(52) U.S. Cl. 29/428

(57) ABSTRACT

A spa shell having an outer perimeter panel and an outer perimeter side surface positioned about the outer perimeter of the spa shell, the side surface comprising a mounting surface for an end user applied façade.

### RELATED APPLICATION DATA

This application is a divisional of and claims priority to U.S. continuation-in-part application Ser. No. 12/185,742, entitled “Apparatus Facilitating Application Of Customized Portable Spa Surrounds By End Users,” filed on Aug. 4, 2008, which claims priority to U.S. application Ser. No. 12/107,686, filed Apr. 22, 2008, the contents of both of which are incorporated herein by reference in their entireties.

### BACKGROUND

1. Field

This disclosure relates to water containing vessels such as spas, hot tubs, whirlpools, pools and the like and more particularly to a portable spa shell having an unfinished side surface applied around it to which decorative façades or surrounds may be applied by an end user/purchaser.

2. Description of Related Art

Portable spas have become quite popular as a result of their ease of use and multiplicity of features such as varied jet and seating configurations. Typically, such portable spas have been self-contained, above-ground units shipped from the factory complete with their decorative exterior surfacing or “surround” in place.

### SUMMARY

The following is a summary description of illustrative embodiments of the invention. It is provided as a preface to assist those skilled in the art to more rapidly assimilate the detailed design discussion which ensues and is not intended in any way to limit the scope of the claims which are appended hereto in order to particularly point out the invention.

According to one illustrative embodiment, an outer perimeter side surface is provided about a spa shell to create a spa unit or “cabinet” which is then sold to an end user of the spa such as, for example, a homeowner. The end user may then select and apply any of a number of various decorative façades or surrounds to the outer perimeter side surface.

In effect, according to illustrative embodiments, the end user is provided with a blank canvas on which to apply siding, surrounds, or façades of his or her choice. In this manner, the end user, landscape architects or contractors, and/or others may customize the appearance of a spa to coordinate with ‘or integrate into’ any selected backyard landscape design or motif or to create any desired appearance. Thus, the phrase “end user applied façade” as used herein refers to any façade, surround, siding, or other decorative surface treatment applied to a spa unit or perimeter side surface by an end user and/or those assisting the end user in such application such as, without limitation, landscape architects, landscape contractors, general contractors, installers, tradesmen, and other individuals.

Façades which may be installed by an end user may include, for example, wood siding, faux or real brick, faux or real slate rock, teak wood, tile, aluminum, brushed steel, flagstone, stucco, or wood or plastic decking.

A spa unit or cabinet as just described further has the advantage that it facilitates embodiments comprising custom spa installations below, or partially below ground or deck level. In embodiments of such installations, the unfinished side surface resides, for example, below deck and the portion above deck may be provided with a decorative façade or surround. Dealers, resellers, and contractors may of course also purchase spa units or cabinets constructed according to the illustrative embodiments and apply decorative facades thereto, for example, for resale to consumers.

Thus, illustrative embodiments may comprise a spa unit design which allows a customer to experience the benefits of hydromassage as delivered by a more traditional above ground portable spa, while facilitating integration of the spa into a larger outdoor landscaping scene, whether by adding some external façade and/or by recessing the spa fully or partially under ground. Various embodiments also better accommodate applications and installations identified by a landscape architect or general contractor or other outdoor construction designer.

In an illustrative embodiment, the outer perimeter side surface of the spa unit is supported by a frame structure disposed between the side surface and the spa shell, which frame structure encompasses the spa shell and may be held in place with respect thereto, for example, by urethane foam.

In certain embodiments, the end user may decide to employ a decorative surround kit as further described herein to create a decorative surround or façade. Such a kit may include a plurality of decoratively surfaced side panels, and a front step dimensioned to integrally mount adjacent a selected side of the surround. In some embodiments, such a kit may further include side rails for mounting about the upper edge of an enclosed spa to create a ledge about the spa perimeter.

### DRAWINGS

The features of the present disclosure will become more apparent with reference to the following description taken in conjunction with the accompanying drawings wherein like reference numerals denote like elements and in which:

FIG. 1 is an exploded perspective view of a decorative spa surround kit according to an illustrative embodiment;

FIG. 2 is a perspective view of the spa kit of FIG. 1 after assembly;

FIG. 3 is a top view of the assembled kit of FIG. 2;

FIG. 4 is a front side view of the assembled kit of FIG. 2;

FIG. 5 is a perspective view illustrating a spa kit on a deck prior to assembly about a spa;

FIG. 6 is a front perspective view illustrating attachment of a front panel of the spa kit;

FIG. 7 is a side perspective view illustrating installation of a right top side rail component;

FIG. 8 is another perspective view illustrating side rail installation;

FIG. 9 is a perspective view illustrating installation of a left corner panel;

FIG. 10 is a perspective view illustrating installation of a back panel component;

FIG. 11 is a front perspective view illustrating installation of a front step component;

FIG. 12 is a front view of a side frame structure according to an illustrative embodiment;

FIG. 13 is a front view of panels attachable to the frame structure of FIG. 12;

FIG. 14 is an side view of the frame structure of FIG. 12 with the panels of FIG. 13 attached thereto;

FIG. 15 is a front view of a front frame structure according to the illustrative embodiment;

FIG. 16 is a front view of a panel attachable to the structure of FIG. 15;

FIG. 17 is an end view of the panel of FIG. 16 with the panels of FIGS. 16 and 18 attached thereto;

FIG. 18 is a front view of second panel attachable to the frame structure of FIG. 15;

FIG. 19 is a sectional view taken at 19-19 of FIG. 15;

FIG. 20 is a sectional view taken at 20-20 of FIG. 15;

FIG. 21 is a front view of a first corner piece frame structure according to an illustrative embodiment;

FIG. 22 is a front view of a second corner piece frame structure according to an illustrative embodiment;

FIG. 23 is a front view of a third corner piece frame structure according to an illustrative embodiment;

FIG. 24 is a bottom view of the frame structure of the illustrative embodiment in the assembled state; and

FIG. 25 is a top view of a brace component of the corner piece of FIG. 23.

FIG. 26 is a side sectional view taken at 26-26 of FIG. 12.

FIG. 27 is a schematic side sectional view illustrating a spa unit structure according to an illustrative embodiment.

### DETAILED DESCRIPTION

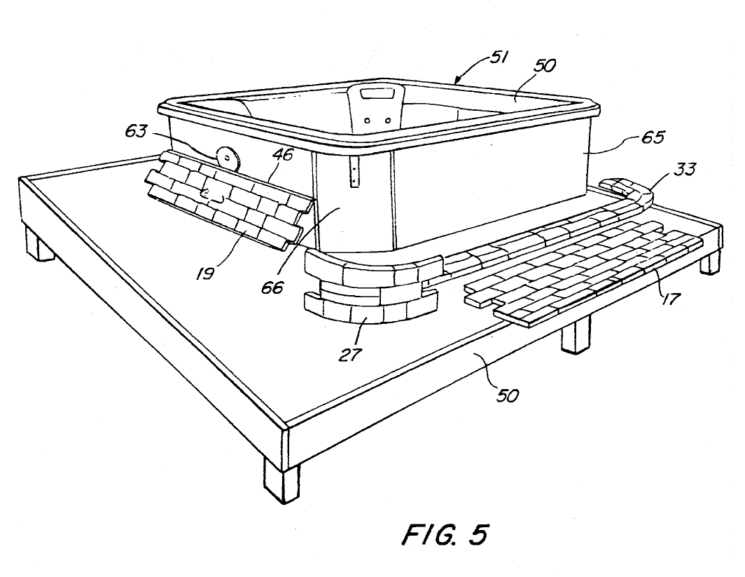

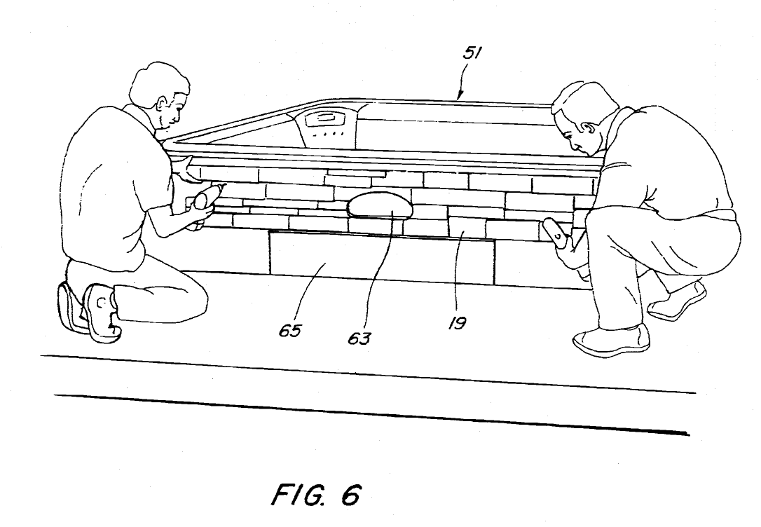

According to an illustrative embodiment, as shown in FIG. 5, a spa unit 51 is provided, which includes a spa shell 50 and an outer perimeter side surface encompassing the spa shell and comprising flat wood facing, e.g. 65, 66. Such facing 65, 66 may comprise, for example, ¾″ or ⅜″ plywood panels suitably cut to provide access, for example, to a spa control panel 63 and spa equipment compartment entrance 165 (FIG. 6). Materials other than plywood may be used for panels 65, 66, for example, such as wood substitute materials, or suitable plastics.

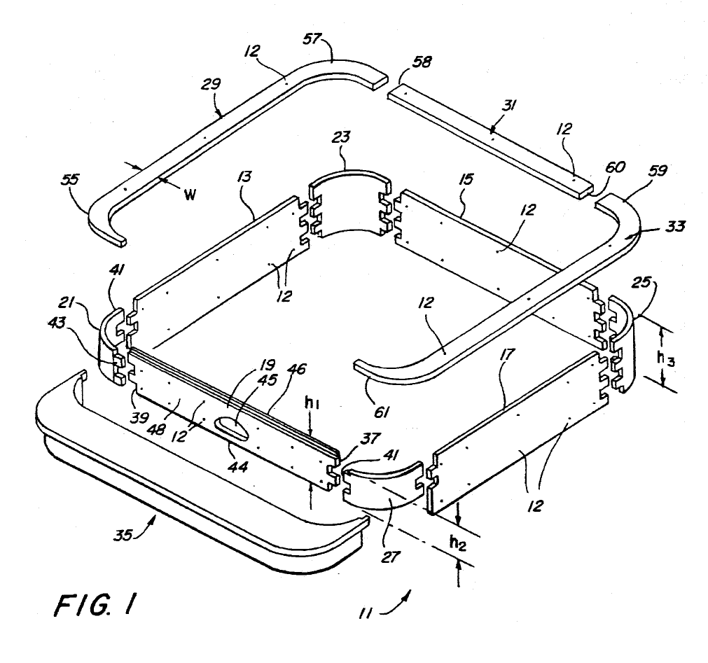

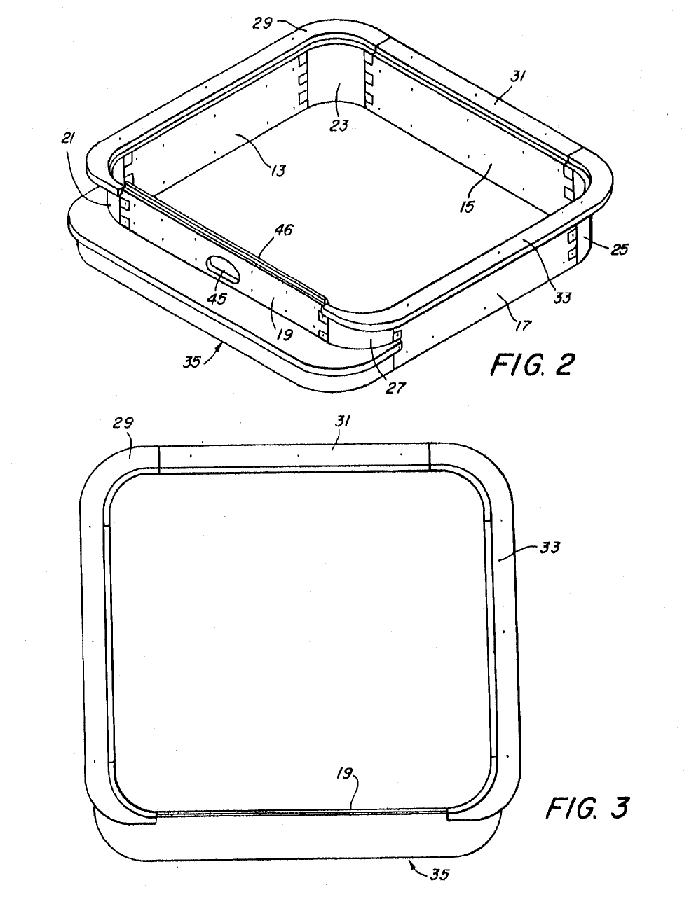

The wood facing 65, 66 facilitates end user application of decorative façades to the spa unit 51, for example, such as a decorative panel surround spa kit 11 as illustrated in FIGS. 1-4. Such a kit 11 may be purchased by an end user and comprises an example of a decorative façade or surround which may be installed about a spa unit of the illustrative embodiment. Other façades, which may be end user-installed may include, for example, wood siding, faux or real brick, faux or real slate rock, teak wood, tile, aluminum, brushed steel, flagstone, stucco, or wood or plastic decking.

The kit 11 of FIGS. 1-4 includes four side panels, 13, 15, 17, 19; four corner panels 21, 23, 25, 27; three side rails 29, 31, 33 and a front step 35. Each of the panels and side rails is provided with suitable screw holes, e.g. 12, to facilitate attachment to a spa unit, e.g. 51 (FIG. 5).

Each of side panels 13, 15, 17, 19 of the decorative surround kit 11 is generally rectangular in shape and has tongue and grooved side edges, e.g. 37, 39. The front panel 19 is of a height “h₁” less than that of the other three side panels 13, 15, 17 to accommodate insertion and attachment of the front step 35 beneath its lower edge 44. The front panel 19 also has an opening 45 formed therein to facilitate access to a spa control panel 63 (FIG. 5).

The panel 19 further has a lip 46 formed at the top edge thereof, which is recessed back from the front face 48 of the panel 19. In an illustrative embodiment, the lip may be, for example, 0.88 inches high, 0.75 inches wide and recessed 0.75 inches from the front face 48. In one embodiment, the lip 46 fits up and behind the overlapping edge 101 of a spa shell 50 when the front panel 19 is installed in the manner as shown in FIG. 6.

Each of the corner panels 21, 23, 25, 27, of the decorative surround kit 11 has tongue and grooved side edges, e.g. 41, 43 and is radially curved or arched through ninety degrees so as to mate at each end in tongue and groove fashion with a respective edge, e.g., 37, 39, of one of the side panels 13, 15, 17, 19. In an illustrative embodiment, the two front corner panels 21, 27 are shorter in height “h₂” than the height of “h₃” of the rear corner panels 23, 25, again to accommodate insertion of the front of step 35 into its assembled position. The height “h₂” of the front corner panels 21, 27 is also less than the height “h₁” of the front panel 19 in order to accommodate the width of the side rails 29, 33 in the embodiment under discussion. The various heights h₁, h₂, h₃ and their relationship to one another may differ in various embodiments.

Two of the side rails 29, 33 of the decorative surround kit 11 have respective curved ends, 55, 57, 59, 61, two of which curve into and abut respective ends 58, 60 of the back side rail 31. Each of the rails 29, 31, 33 is of a width “w” selected to extend beyond the lip 101 of a spa shell, e.g. 50, FIG. 5, to form a ledge 104, as shown in FIGS. 10 and 11.

All of the components of the decorative surround kit 11 illustrated in FIG. 1 may be made of urethane foam and may be finished or decoratively surfaced on their outer faces to give the appearance, for example, of brick or stone facing. Such decorative surfacing is illustrated in FIGS. 5-11, but is omitted in FIGS. 1-4 for clarity of illustration. The side panels 13, 15, 17, 19 and corner pieces 21, 23, 25, 27 may be fabricated from 15 lb. density urethane foam, while the front step 35 may be fabricated from 60 lb. density foam.

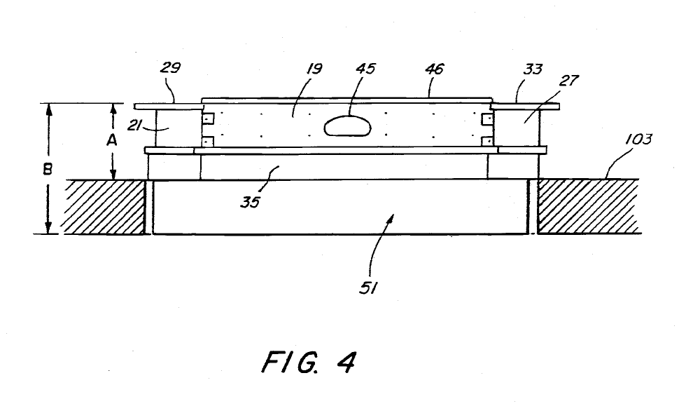

In an illustrative embodiment shown in FIG. 4, the height “A” of the panel and step assembly may be, e.g. 20 inches, with respect to the height “B” of a spa unit 51 of, e.g. 48 inches. Thus, the surround kit of the illustrative embodiment can be installed on a spa unit 51 which is sunk into a surrounding deck 103 to form an attractive and highly functional spa recreational facility. Alternatively, spa surround panels such as illustrated may run the full height of the spa in an entirely out-of-ground or out-of-deck installation.

The manner of installation of the illustrative spa surround kit is further illustrated in FIGS. 5-11. Initially, as shown in FIG. 5, the spa unit 51 is provided with an outer perimeter side surface comprising a flat wood facing, e.g. 65, 66, such as, for example, ¾″ or ⅜″ sealant treated BCX plywood sheets suitably cut to provide access to the spa control panel 63 and spa equipment compartment entrance 165 (FIG. 6) containing, for example, a pump and filter and/or other controls. Materials other than plywood may be used for panels 65, 66, for example, such as wood substitute materials, or suitable plastics.

As further shown in FIG. 5, the panels, side rails, and corner pieces, e.g. 17, 19, 27, 33 are first laid out on the deck 103 around the spa unit 51. Then the front panel 19 may be installed around the control panel 52 using, e.g. screw fasteners, as shown in FIG. 6.

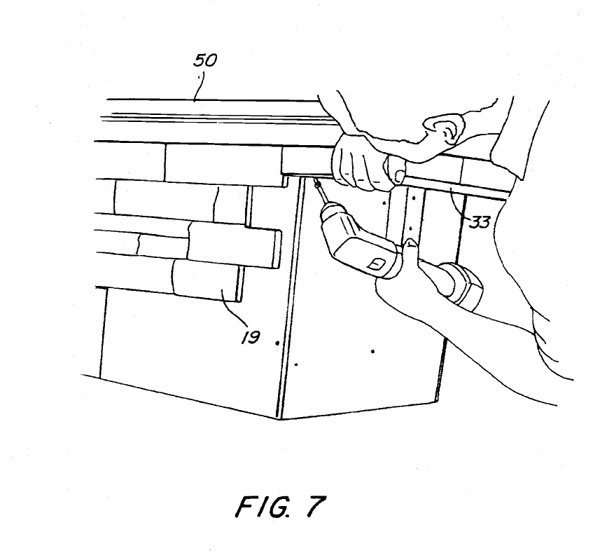

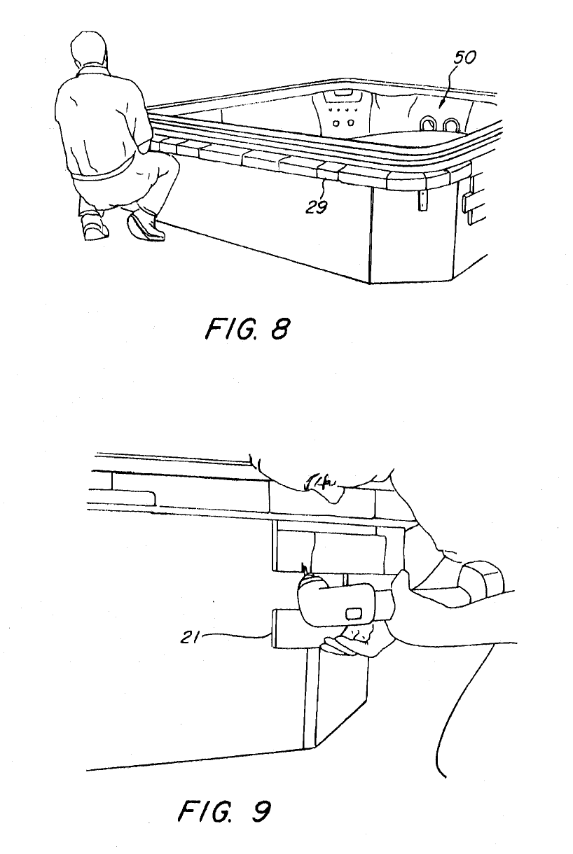

Next, the side rails 29, 31, 33 are each installed, beginning, for example, with attachment of the right side rail 33 and then the left side rail 29, as illustrated in FIGS. 7 and 8, and then the back side rail 31. After installation, the side rails 29, 31, 33 are each positioned flush against the plywood facing, e.g. 65, and flush against the overlapping spa edge 101 and screwed or otherwise fastened into suitably disposed wood framing.

After installation of the side rails 29, 31, 33, the remaining panels, 21, 13, 23, 15, 25, 17, 27 are successively installed beginning, for example, with the left corner panel 21 (FIG. 9) and proceeding clockwise around the spa unit 51, see e.g. FIGS. 9, 10. The top edges of the panels 21, 13, 23, 15, 25, 17, 27 are positioned with their top edges flush against the underside of the side rails 29, 31, 33 and with their inner side surfaces flush against the plywood side panels and then screwed or otherwise fastened into place. Finally, the front step 35 is placed against the left side of the unit (FIG. 11), then pushed into its finished position, and finally fastened in place, e.g. by suitable screws or other fasteners.

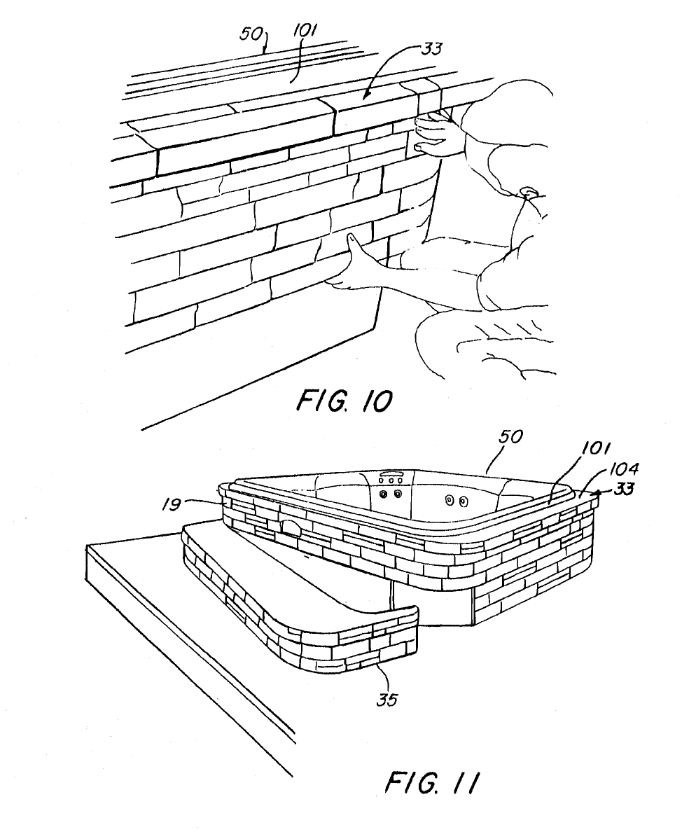

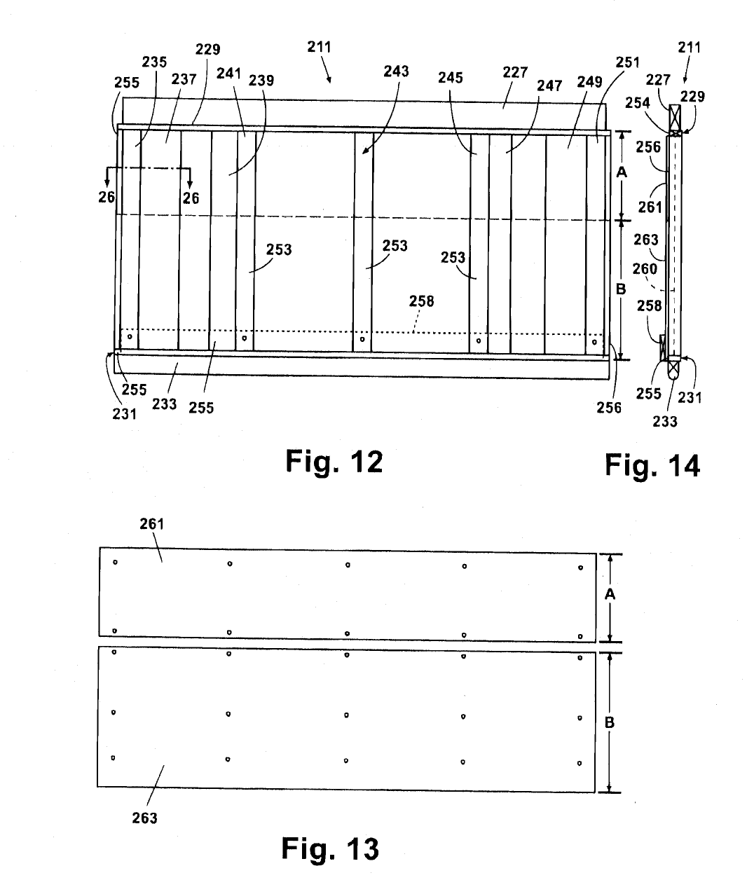

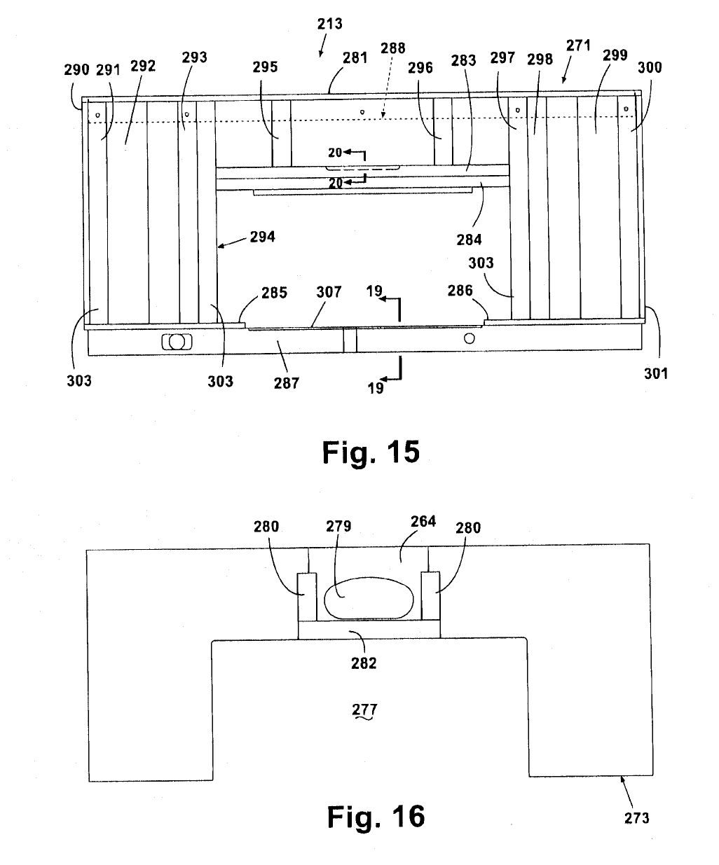

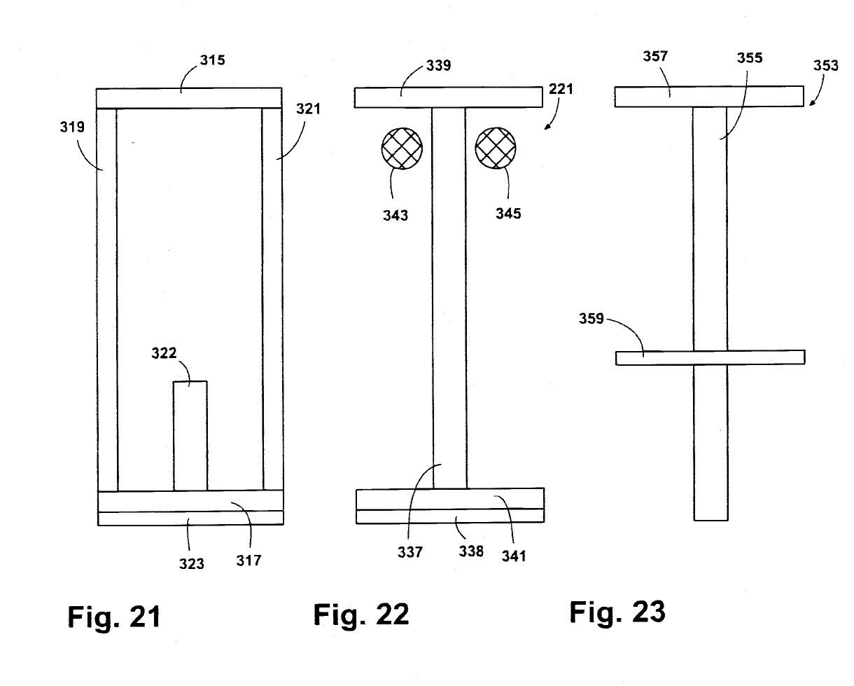

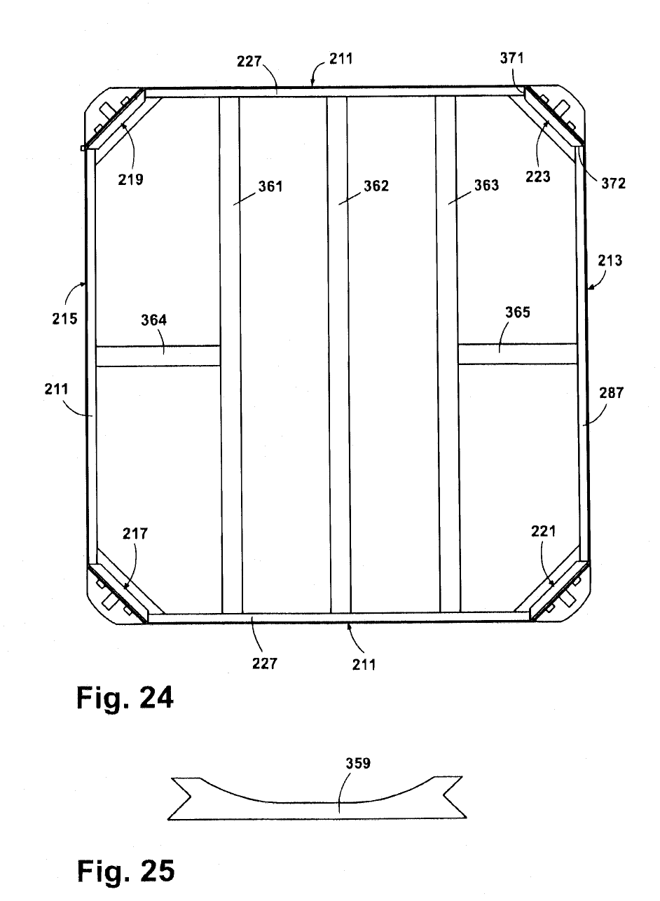

FIGS. 12 to 25 illustrate a frame structure, which may be used in various embodiments to retain the flat wood facing or panels, e.g. 65, 66 (FIG. 5) in position. This frame structure includes two side panel frame structures 211 (FIG. 12), a front panel frame structure 213 (FIG. 15), a back panel frame structure 215, and four corner panels frame structures 217, 219, 221, 223 (FIGS. 21-23.) The layout and interconnection of the side, front, back, and corner panels via suitable fastening devices such as screws and/or nails panels is illustrated in FIG. 24, which will be discussed in more detail after a description of the individual frame structure components.

FIGS. 12 to 14 illustrate one of the side panel frame structures and attached plywood panels 261, 263, adapted to attach thereto in more detail. The structure 211 is constructed of lumber, wood substitute, or other suitable materials and includes four horizontal frame members 227, 229, 231, 233, as well as vertical frame members 235, 237, 239, 241, 243, 245, 247, 249, 251. The frame structure 211 further includes first and second end pieces 255, 256. The end view of FIG. 14 shows the panels 261, 263 attached to the frame structure 211.

Each of the vertical frame members 235, 237, 239, 241, 243, 245, 247, 249, 251 is rectangular in shape and positioned between and fastened to the upper and lower horizontal frame members 229, 231. In an illustrative embodiment, the upper and lower horizontal frame members 229, 231 may respectively be “1×1¾” and “1×2” lumber, respectively, and of the same length, e.g. 671/4 inches. An additional horizontal rectangular member 258 is attached for protection during transportation, and is removed thereafter.

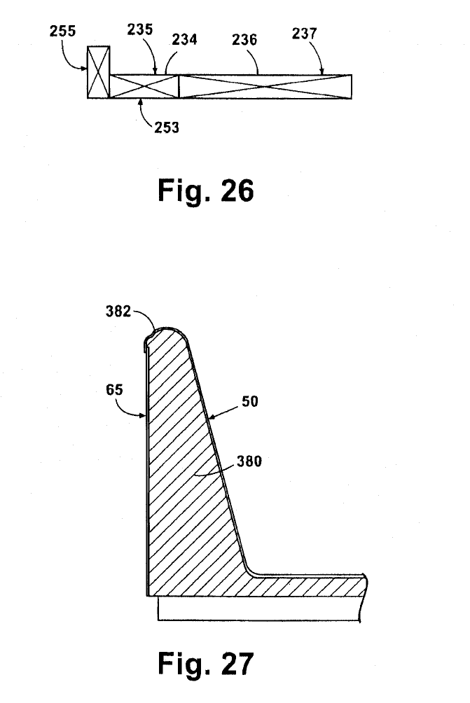

In the illustrative embodiment, five of the vertical frame members 235, 241, 243, 245, 251 may comprise identically shaped “1×3” lumber parts of a selected height, e.g. 30 inches. The vertical frame members 237, 249 may be, for example, 1″×6″×30″ lumber, while the vertical members 239, 247 may be 1″×3″×30″ lumber. In an illustrative embodiment, the front face, e.g. 253, of each of the vertical frame members 235, 237, 239, 241, 243, 245, 247, 249, 251 is fastened flush with the front edges 254, 255 of the respective horizontal frame members 229, 231, thereby providing co-planar front surfaces 253 on which to attach the first and second plywood panels 261, 263 shown in FIG. 13, using, for example, screws or any other suitable fastening device. Use of two panels 261, 263, facilitates upper panel removal for service in an application, for example, where the lower panel 263 is located beneath the surface of a deck. The rear face 234, 236 of each of the vertical frame members lies in the plane of phantom line 260 of FIG. 14, as further illustrated with respect to vertical members 255, 235, 237 in FIG. 26.

The horizontal frame members 227, 233 may be 2″×4″ and 2″×2½″ lumber pieces, respectively. The frame member 227 provides a “kick plate” at the bottom of the spa unit 51, while member 233 comprises a bull nose shaped to mate with the interior contour of the bar top 382 of the spa shell 50 (e.g. FIG. 27). In one embodiment, the connection between the bull nose of the front, back and side panels may be secured to the spa bar top using, for example, 30 lb urethane foam for the front and back panel and 3.5 lb urethane foam for the side panels. The front panel bull nose is not illustrated in the figures, but may be similar to that of the front and side panels and similarly attached.

In the illustrative embodiment, the back panel 215 may be constructed in the same fashion as the side panels 211 utilizing the same horizontal and vertical frame parts, with the exception that the horizontal frame parts corresponding to members 229, 231 are longer in length, for example, 74⅜ inches.

FIGS. 15 to 20 illustrate a front panel 213 according to an illustrative embodiment. The front panel 213 is generally designed to accommodate access to a spa equipment compartment, as well as a spa control panel area. Accordingly, the front panel 213 includes a frame structure 271 to which is attached two plywood panels 273, 275 (FIGS. 16, 18). The first plywood panel 273 of FIG. 16 is generally “U”-shaped, providing a “cut-out” area 277 to expose, for example, a door to a spa equipment compartment. The second plywood panel 275 of FIG. 18 is sized to fit flushly into the cut-out 277 and to fasten to the frame members, e.g. 294, 297 by, for example, four screws or other suitable fastening devices, so that the panel 275 may be removed, if necessary, to provide access to the equipment compartment.

The first plywood panel 273 further has an oblong opening 279 formed therein suitably located to provide access to the spa control panel of a spa unit 51 positioned within the frame structure. The region 264 around the control panel opening 279 is preferably painted black to provide a suitable background for the panel, and control panel protecting braces (1″×3″) 280, 282 are attached to the front of the panel 273.

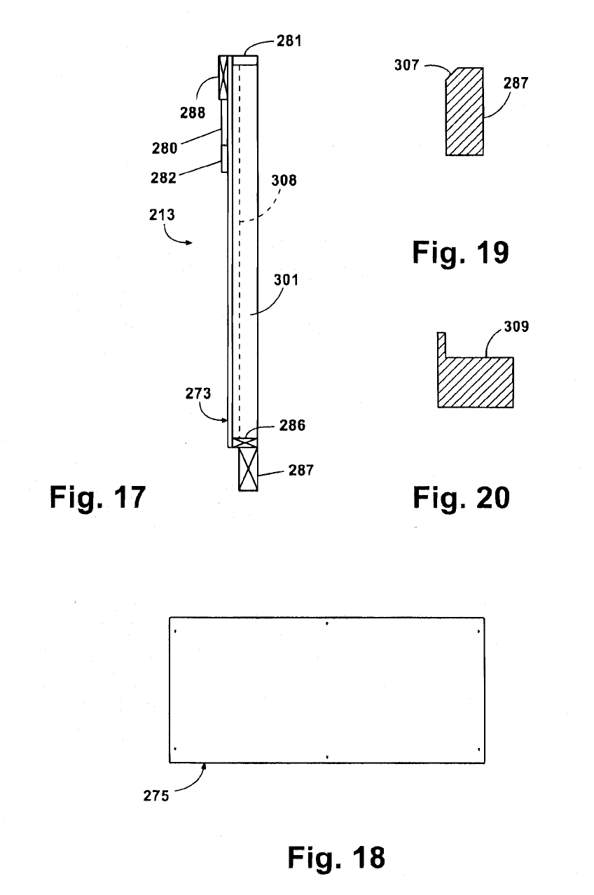

The front panel frame 271 includes 6 horizontal members 281, 283, 284, 285, 286, 287 and 10 vertical members 290, 291, 292, 293, 294, 295, 296, 297, 298, 299, 300, 301. As with the side panels 211, the horizontal members 281, 285, 286 fasten directly to the vertical members 290, 291, 292, 293, 294, 297, 298, 299, 300, 301. The vertical members 292 and 299 are recessed, and receive screws attaching the decorative front panel 19 to the unit 51. As in FIG. 12, the vertical members 291, 293, 297, 294, 298, 299 provide co-planar mounting faces, e.g. 303, for fastening the panels, 273, 275. The rear faces of these vertical members lie in the plane of phantom line 308 shown in FIG. 17. The horizontal cross-members 283, 284 provide support and a fastening surface for the panels 273, 275 above the opening 277, and the vertical members 295, 296 are fastened between cross-member 283 and upper horizontal member 281.

In an illustrative embodiment, the vertical members 290, 291, 293, 294, 295, 296, 297, 298 may be 1″×3″ wood pieces, the cross-members 283, 284, 2″×2″ lumber parts, and the vertical members 292, 299 1″×6″ lumber parts. The top and bottom horizontal frame members 281, 285 may be 1″×3″ lumber parts cut down to 1″×2″, while member 286 may be a 1″×3″ lumber part. The additional horizontal frame member 287 is fastened across the bottom edge of the structure to provide additional support and may be, for example, a 2″×4″ lumber part. A horizontal member 288 is again provided for protection during shipping and thereafter removed.

As illustrated in FIGS. 19 and 20, various structural features may be provided in various embodiments to accommodate varying aspects of the design and positioning of the spa and related equipment enclosed within the frame structure, for example, for ease of use, to provide safety, and/or to facilitate attachment of accessories. For example, FIG. 19 shows a slight bevel 307 applied to the edge of the bottom horizontal frame members 287 to provide air flow. Similarly, FIG. 20 illustrates a recess 309 provided along a segment of the cross-member 283 in order to facilitate control panel installation.

As may be appreciated, four corner panels 217, 219, 221, 223 are also employed in the illustrative embodiment and comprise flat plywood faces like panel 66 shown in FIG. 5. FIGS. 21 to 23 show illustrative embodiments of frame structures for supporting the flat plywood faces of such corner pieces. FIG. 21 particularly illustrates a frame structure suitable for two back panel corners 217, 219. This structure may employ 2″×4″ horizontal frame members 315, 317, 323, 1″×2″ vertical frame members 319, 321 and a 1″×3″ vertical frame segment 322. The frame member 323 supports the top edge or “bar top” of the plastic spa shell, e.g. 50 (FIG. 5, 27), while frame segment 322 provides support for a cover buckle.

A front panel frame structure 221 is illustrated in FIG. 22. This frame structure 221 includes a centrally positioned 2″×3″ vertical frame member 337 and respective upper and lower 2″×4″ horizontal frame members 339, 341. Screens 343, 345 are installed over circular apertures in the plywood surface applied to the frame structure 221, which apertures provide exhaust outlets positioned to cooperate with exhaust outlets of the enclosed spa equipment. Horizontal member 338 again supports the spa bar top.

The fourth corner piece frame 223 of FIG. 23 includes a 2″×3″ centered vertical frame member 355 and a 2″×4″ top horizontal frame member 357. The frame 353 further includes a horizontal brace 359, which is specially cut since the frame 353 is positioned at a corner of the particular spa in question which contains the filter compartment. FIG. 25 shows further detail of the CNC cut brace 359, which functions to keep the side panel supported by frame 353 at a proper distance and in the proper position.

It will be appreciated that the four corner frames 217, 219, 221, 223 and attached plywood facing are used in the illustrative embodiment to appropriately match the contour of the particular spa shell 50 enclosed by the frame structure, which may be, for example, a HotSprings® “Grandee” model, as manufactured by Watkins Manufacturing Corporation, Vista, Calif. Various other embodiments need not employ such corner pieces and may be constructed to conform to any one of numerous geometric or other shapes.

FIG. 24 provides a bottom view of the assembled frame structure, which includes bottom frame members 361, 362, 363, 364, 365, which may be, for example, 2″×3″ support members suitably fastened to their cooperating members. FIG. 24 further illustrates the mitred or “butterfly” edges, e.g. 371, 372, on the respective corner pieces 217, 219, 221, 223, which facilitate their fitting together with the front, back, and side panels 213, 215, 211. After the eight sided frame structure with plywood panels of the illustrative embodiment is assembled, the cooperating plastic spa shell 50 is placed into it, resting on the bottom frame members 361, 362, 363, 364, 365. Urethane foam 381 of suitable density is then shot into the spaces between the frame members and the spa shell 50 to capture the frame members and retain them in place with respect to the spa shell 50 to form a finished spa unit 51. The nature of the resulting structure is illustrated schematically in FIG. 27 with frame detail omitted.

Those skilled in the art will appreciate that various adaptations and modifications of the just described embodiment can be configured without departing from the scope and spirit of the invention. Therefore, it is to be understood that, within the scope of the appended claims, the invention may be practiced other than as specifically described herein.

What is claimed:

1. A method comprising:
providing a spa shell having an outer perimeter;
providing a frame structure surrounding and supporting the spa shell;
affixing a plurality of flat generally rectangular panels to the frame structure, said panels providing a plurality of generally flat mounting surfaces surrounding the spa shell; and
enabling an end user to select one of a plurality of decorative façades for application to said generally rectangular panels, each façade comprising a plurality of decorative panels, any one of which façades may be selected and applied to the generally flat mounting surfaces to thereby achieve a customized appearance and custom spa installation.

2. A method comprising:
providing a spa shell having an outer perimeter;
providing a frame structure surrounding and supporting the spa shell;
affixing a plurality of flat generally rectangular panels to the frame structure, said panels providing a plurality of generally flat mounting surfaces surrounding the spa shell;
installing the spa shell along with the affixed generally rectangular panels such that a portion of the spa shell and associated areas of said generally rectangular panels lie beneath an adjacent surrounding surface; and
constructing a plurality of decorative façades, each façade comprising a plurality of decorative panels, each decorative façade having its respective decorative panels shaped and dimensioned to attach to the portions of said rectangular panels which lie above said surface, any one of which decorative façades may be selected and applied to the generally flat mounting surfaces to provide a façade having a customized appearance, thereby resulting in a custom spa installation.

3. The method of claim 2 further comprising selecting the height of one of the decorative panels of a first decorative façade to be less than that of a plurality of other decorative panels of the first decorative façade in order to facilitate mounting of a step adjacent said first decorative façade.

4. The method of claim 1 further comprising selecting the height of one of the decorative panels of a first decorative façade to be less than that of a plurality of other decorative panels of the first decorative façade in order to facilitate mounting of a step adjacent said first decorative façade.
